(19) United States
(12) Patent Application Publication
(10) Pub. No.: US 2016/0205628 A1
(43) Pub. Date: Jul. 14, 2016

(54) MOBILE COMMUNICATION METHOD, RADIO TERMINAL, AND RADIO BASE STATION

(71) Applicant: KYOCERA CORPORATION, Kyoto-shi, Kyoto (JP)

(72) Inventor: Kazuya KONNO, Leawood, KS (US)

(73) Assignee: Kyocera Corporation, Kyoto-shi, Kyoto (JP)

(21) Appl. No.: 14/912,700

(22) PCT Filed: Aug. 18, 2014
(86) PCT No.: PCT/JP2014/071549

§ 371 Date: Feb. 18, 2016

(30) Foreign Application Priority Data
Aug. 20, 2013 (JP) 2013-170239

(51) Int. Cl. H04W 52/02

(52) U.S. Cl. CPC H04W 52/0225

(57) ABSTRACT

A mobile communication method comprises a step A of notifying the radio base station, from the radio terminal, of a category class indicating a category of the radio terminal, a step B of notifying the radio terminal, from the radio base station, of DRX identification information for identifying a DRX cycle that is determined depending on the category class notified from the radio terminal, and a step C of monitoring the downlink signal in the On duration in the radio terminal depending on the DRX cycle that is identified by the DRX identification information.

### TECHNICAL FIELD

The present invention relates to a mobile communication method, a radio terminal, and a radio base station used in a mobile communication system that configures a DRX cycle including an On duration in which a downlink signal is monitored and an Off duration in which the downlink signal is not monitored.

### BACKGROUND ART

Conventionally, there has been known a mobile communication system that adopts a DRX (Discontinuous Reception) setting a duration in which a radio terminal monitors a downlink signal transmitted from a radio base station (hereinafter, referred to as On duration) and a duration in which the radio terminal does not monitor the downlink signal transmitted from the radio base station (hereinafter, referred to as Off duration) (for example, Non Patent Literature 1). For example, as such a mobile communication system, LTE (Long Term Evolution) has been known.

The DRX cycle configured by the On duration and the Off duration is generally broadcast from a network (radio base station). The same DRX cycle is used in a cell managed by the radio base station. It is noted that, two cycles (a short DRX cycle and a long DRX cycle) are regulated as the DRX cycle.

However, there may be very few opportunities in which communication is performed between the radio terminal and the radio base station depending on an operation state of the radio terminal. In such a case, it is impossible to sufficiently reduce power consumption of the radio terminal having few communication opportunities when the same DRX cycle is applied in a cell without relying on the operation state of the radio terminal.

Further, it is also considered that a downlink signal transmitted from the radio base station is monitored only in any one On duration of a plurality of On durations and a downlink signal transmitted from the radio base station is not monitored in the remaining On durations in order to sufficiently reduce power consumption of a radio terminal which has few communication opportunities. However, in an On duration in which the downlink signal transmitted from the radio base station is not monitored, it is not preferable to adopt such a configuration because it is not possible to receive the downlink signal transmitted from the radio base station (for example, a paging signal).

### CITATION LIST

### Non Patent Literature

[NPL 1] TS36.321 V10.0.0

### SUMMARY OF INVENTION

A mobile communication method according to a first aspect is a method of configuring a DRX cycle including an On duration in which a downlink signal is monitored and an Off duration in which the downlink signal is not monitored between a radio terminal and a radio base station. The mobile communication method comprises a step A of notifying the radio base station, from the radio terminal, of a category class indicating a category of the radio terminal, a step B of notifying the radio terminal, from the radio base station, of DRX identification information for identifying a DRX cycle that is determined depending on the category class notified from the radio terminal, and a step C of monitoring the downlink signal in the On duration in the radio terminal depending on the DRX cycle that is identified by the DRX identification information.

A radio terminal according to a second aspect is used in a mobile communication system that configures a DRX cycle including an On duration in which a downlink signal is monitored and an Off duration in which the downlink signal is not monitored. The radio terminal comprises: a notification unit configured to notify a radio base station of a category class indicating a category of the radio terminal, and a controller configured to monitor the downlink signal in the On duration depending on a DRX cycle that is determined by the radio base station depending on the category class of the radio terminal.

A radio base station according to a third aspect is used in a mobile communication system that configures a DRX cycle including an On duration in which a downlink signal is monitored and an Off duration in which the downlink signal is not monitored. The radio base station comprises: a receiver configured to receive a category class indicating a category of a radio terminal from the radio terminal, and a notification unit configured to notify the radio terminal of DRX identification information for identifying the DRX cycle that is determined depending on the category class of the radio terminal.

A mobile communication method according to a fourth aspect comprises a step A of notifying, by a radio terminal, a radio base station of a category class, a step B of notifying, by the radio base station, the radio terminal of DRX identification information for identifying a DRX cycle depending on the notified category class, and a step C of monitoring, by the radio terminal, a downlink signal depending on the DRX cycle that is identified by the DRX identification information.

A radio terminal according to a fifth aspect notifies a radio base station of a category class, and applies a DRX cycle corresponding to DRX identification information notified from the radio base station depending on the category class.

A radio base station according to a sixth aspect notifies a radio terminal of DRX identification information for identifying a DRX cycle depending on a category class notified from the radio terminal.

### BRIEF DESCRIPTION OF DRAWINGS

FIG. 1 is a diagram illustrating a mobile communication system 100 according to a first embodiment.

FIG. 2 is a diagram illustrating a radio frame according to the first embodiment.

FIG. 3 is a diagram illustrating a radio resource according to the first embodiment.

FIG. 4 is a diagram illustrating a DRX according to the first embodiment.

FIG. 5 is a block diagram illustrating a UE 10 according to the first embodiment.

FIG. 6 is a block diagram illustrating an eNB 110 according to the first embodiment.

FIG. 7 is a diagram illustrating one example of a table according to the first embodiment.

FIG. 8 is a diagram illustrating one example of a table according to the first embodiment.

FIG. 9 is a diagram illustrating one example of a table according to the first embodiment.

FIG. 10 is a sequence diagram illustrating a mobile communication method according to the first embodiment.

### DESCRIPTION OF EMBODIMENTS

A mobile communication system according to an embodiment of the present invention is described below with reference to the drawings. Note that, in the following description of the drawings, same or similar reference signs denote same or similar elements and portions.

Note that the drawings are merely schematically shown and proportions of sizes and the like are different from actual ones. Thus, specific sizes and the like should be judged by referring to the description below. In addition, there are of course included portions where relationships or percentages of sizes of the drawings are different with respect to one another.

### Overview of Embodiments

A mobile communication method according to embodiments is a method of configuring a DRX cycle including an On duration in which a downlink signal is monitored and an Off duration in which the downlink signal is not monitored between a radio terminal and a radio base station. The mobile communication method comprises a step A of notifying the radio base station, from the radio terminal, of a category class indicating a category of the radio terminal, a step B of notifying the radio terminal, from the radio base station, of DRX identification information for identifying a DRX cycle that is determined depending on the category class notified from the radio terminal, and a step C of monitoring the downlink signal in the On duration in the radio terminal depending on the DRX cycle that is identified by the DRX identification information.

In the embodiments, it is possible to set the appropriate DRX cycle because the DRX cycle is determined depending on the category class of the radio terminal by notifying the radio base station, from the radio terminal, of the category class of the radio terminal that is allowed to be recognized only in the radio terminal.

That is, in the conventional mobile communication method, the same DRX cycle is fixedly prescribed in a cell. However, in the embodiments, it is possible to flexibly set the DRX cycle.

### First Embodiment

### Mobile Communication System

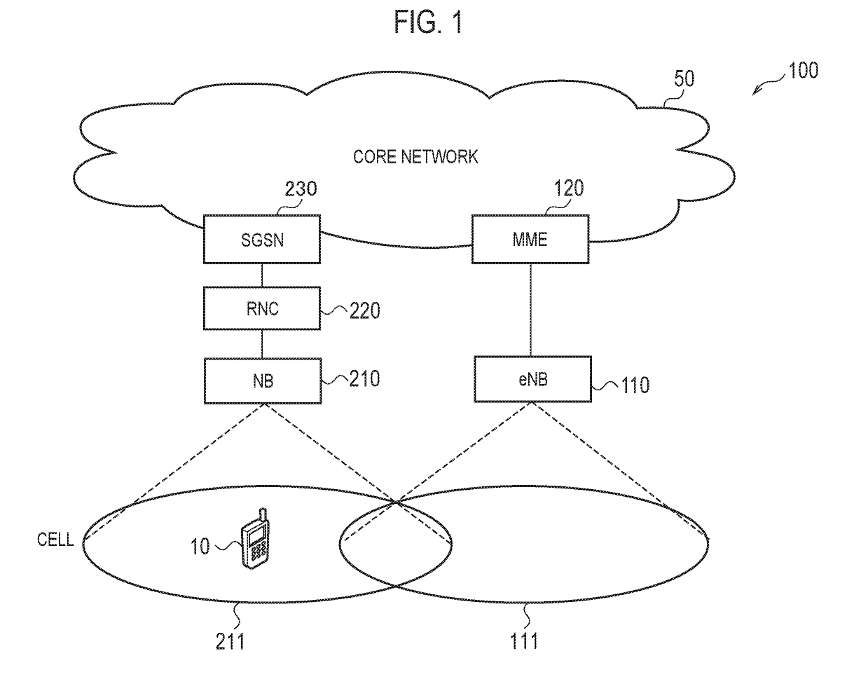

Hereinafter, a mobile communication system according to a first embodiment will be described. FIG. 1 is a diagram illustrating a mobile communication system 100 according to the first embodiment.

As illustrated in FIG. 1, the mobile communication system 100 includes a radio terminal 10 (hereinafter, referred to as UE 10) and a core network 50. Further, the mobile communication system 100 includes a first communication system and a second communication system.

The first communication system, for example, is a communication system corresponding to LTE (Long Term Evolution). The first communication system, for example, includes a radio base station 110 (hereinafter, referred to as eNB 110) and an MME 120. In the first communication system, it is noted that a first RAT (EUTRAN; Evolved Universal Terrestrial Access Network) is used.

The second communication system, for example, is a WCDMA (Wideband Code Division Multiple Access)-compatible communication system. The second communication system includes a radio base station 210, an RNC 220, and an SGSN 230. In the second communication system, it is noted that a second RAT (UTRAN; Universal Terrestrial Access Network) is used.

The UE 10 is a device (User Equipment) configured to communicate with the first communication system and the second communication system. For example, the UE 10 has a function of performing radio communication with the eNB 110, and a function of performing radio communication with the radio base station 210.

The eNB 110, including a cell 111, is a device (evolved NodeB) that performs radio communication with the UE 10 which is present in the cell 111.

The MME 120 is a device (Mobility Management Entity) that manages the mobility of the UE 10 which establish a radio connection with the eNB 110. The MME 120 is provided in the core network 50.

The radio base station 210, including a cell 211, is a device (NodeB) that performs radio communication with the UE 10 which is present in the cell 211.

The RNC 220, connected to the radio base station 210, is a device (Radio Network Controller) that establishes a radio connection (RRC Connection) with the UE 10 which is present in the cell 211.

The SGSN 230 is a device (Serving GPRS Support Node) that performs packet switching in a packet switching domain. The SGSN 230 is provided in the core network 50. Although not illustrated in FIG. 1, a device (MSC; Mobile Switching Center) that performs circuit switching in a circuit switching domain may be provided in the core network 50.

Hereinafter, the first communication system will be mainly described, below. It is noted that the following description may also be applied to the second communication system. Further, a cell should be understood as a function of performing radio communication with the UE 10. It is noted that the cell may also be considered as a service area indicating a range communicable with the cell.

Here, in the first communication system, an OFDMA (Orthogonal Frequency Division Multiple Access) scheme is used as a downlink multiplexing scheme, and an SC-FDMA (Single-Carrier Frequency Division Multiple Access) scheme is used as an uplink multiplexing scheme.

Further, in the first communication system, an uplink channel includes an uplink control channel (PUCCH; Physical Uplink Control Channel), an uplink shared channel (PUSCH; Physical Uplink Shared Channel), and the like. Further, a downlink channel includes a downlink control channel (PDCCH; Physical Downlink Control Channel), a downlink shared channel (PDSCH; Physical Downlink Shared Channel), and the like.

The uplink control channel is a channel that transfers a control signal.

The control signal, for example, includes CQI (Channel Quality Indicator), PMI (Precoding Matrix Indicator), RI (Rank Indicator), SR (Scheduling Request), ACK/NACK, and the like.

The CQI is a signal that notifies a recommended modulation scheme and an encoding rate to be used in downlink transmission. The PMI is a signal indicating a precoder matrix which is preferably used for the downlink transmission. The RI is a signal indicating the number of layers (the number of streams) to be used in the downlink transmission. The SR is a signal that requests an assignment of an uplink radio resource (a resource block which will be described later). The ACK/NACK is a signal indicating whether or not a signal transmitted via the downlink channel (for example, the PDSCH) has been successfully received.

The uplink shared channel is a channel that transfers a control signal (including the above-mentioned control signal) and/or a data signal. For example, the uplink radio resource may be assigned only to the data signal, or assigned such that the data signal and the control signal are multiplexed.

The downlink control channel is a channel that transfers a control signal. The control signal, for example, includes Uplink SI (Scheduling Information), Downlink SI (Scheduling Information), and a TPC bit.

The Uplink SI is a signal indicating the assignment of the uplink radio resource. The Downlink SI is a signal indicating the assignment of a downlink radio resource. The TPC bit is a signal that indicates increase or decrease in the power of a signal transmitted via the uplink channel.

The downlink shared channel is a channel that transfers a control signal and/or a data signal. For example, the downlink radio resource may be assigned only to the data signal, or assigned such that the data signal and the control signal are multiplexed.

It is noted that a control signal transmitted via the downlink shared channel includes TA (Timing Advance). The TA is transmission timing correction information between the UE 10 and the eNB 110, and is measured by the eNB 110 on the basis of an uplink signal transmitted from the UE 10.

Further, a control signal transmitted via a channel, other than the downlink control channel (the PDCCH) and the downlink shared channel (the PDSCH), includes the ACK/NACK. The ACK/NACK is a signal indicating whether or not a signal transmitted via the uplink channel (for example, the PUSCH) has been successfully received.

### Radio Frame

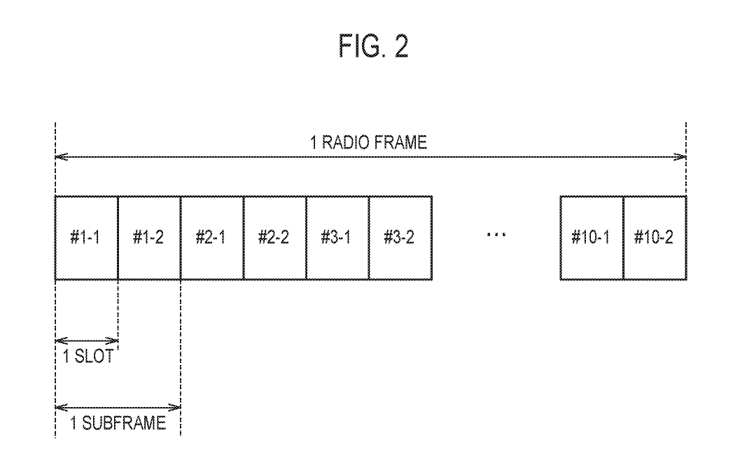

A radio frame in the first communication system will be described, below. FIG. 2 is a diagram illustrating the radio frame in the first communication system.

As illustrated in FIG. 2, one radio frame is configured by 10 subframes and one subframe is configured by two slots. One slot has a time length of 0.5 msec, one subframe has a time length of 1 msec, and one radio frame has a time length of 10 msec.

It is noted that one slot is configured by a plurality of OFDM symbols (for example, six OFDM symbols or seven OFDM symbols) in a downlink. Similarly, one slot is configured by a plurality of SC-FDMA symbols (for example, six SC-FDMA symbols or seven SC-FDMA symbols) in an uplink.

### Radio Resource

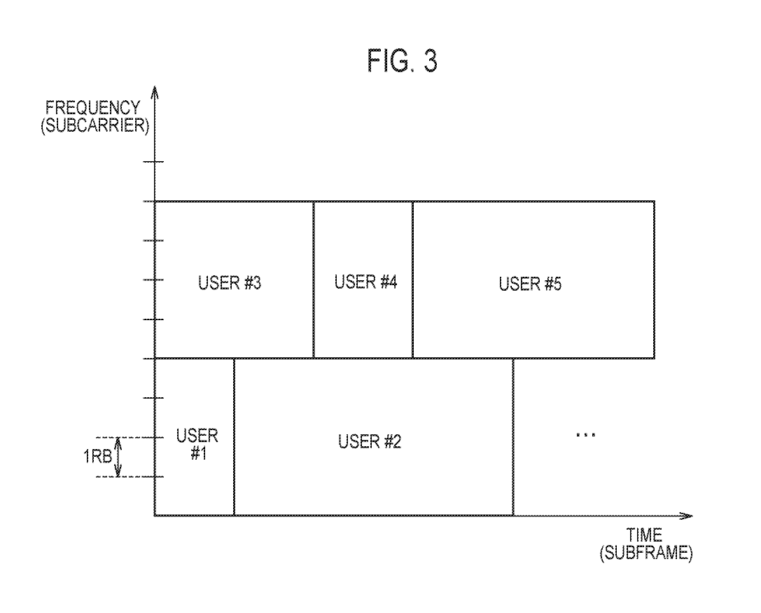

A radio resource in the first communication system will be described, below. FIG. 3 is a diagram illustrating the radio resource in the first communication system.

As illustrated in FIG. 3, the radio resource is defined by a frequency axis and a time axis. A frequency is configured by a plurality of subcarriers, and a predetermined number of subcarriers (12 subcarriers) are collectively called a resource block (RB). As described above, a time has a unit, such as the OFDM symbol (or the SC-FDMA symbol), the slot, the subframe, and the radio frame.

Here, the radio resource is assignable to each one resource block. Further, on the frequency axis and the time axis, it is possible to divide and assign the radio resources to a plurality of users (for example, a user #1 to a user #5)

Further, the radio resource is assigned by the eNB 110. The eNB 110 is assigned to each UE 10 on the basis of the CQI, the PMI, the RI, and the like.

### Discontinuous Reception

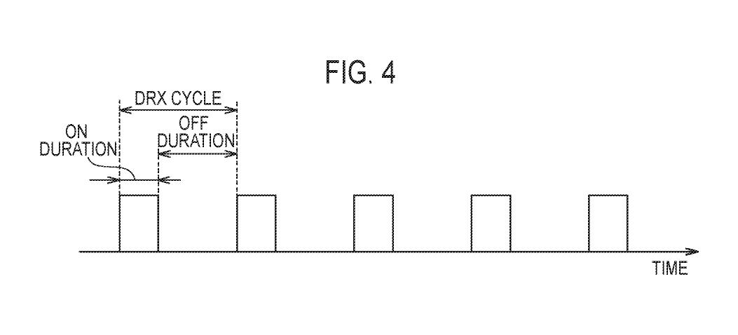

A discontinuous reception (DRX) will be described, below. FIG. 4 is a diagram for describing the discontinuous reception. In order to reduce power consumption, it is possible for the UE 10 to configure the discontinuous reception in a connected state or an idle state. Here, the eNB 110 is exemplified as a radio base station, however, the embodiment is not limited thereto. The radio base station may be the radio base station 210.

As illustrated in FIG. 4, the DRX cycle has the On duration in which the UE 10 monitors a downlink signal and the Off duration in which the UE 10 does not monitor the downlink signal. The UE 10 monitors the downlink signal in the On duration.

In the first embodiment, the UE 10 notifies the eNB 110 of a category class indicating a category of the UE 10 (hereinafter, referred to as UE_CATEGORY_CLASS).

The UE_CATEGORY_CLASS as used herein may indicate an operation category corresponding to an operation (current operation) of the UE 10. Alternatively, instead of being the operation category corresponding to the operation (current operation) of the UE 10, or in addition to indicate the operation category corresponding to the operation of the UE 10, the UE_CATEGORY_CLASS may indicate a category such as a type category or a status category corresponding respectively to at least the type or status of the UE 10.

The eNB 110 notifies the UE 10 of DRX identification information (hereinafter, referred to as DRX_CYCLE_INDEX) for identifying the DRX cycle that is determined depending on the notified UE_CATEGORY_CLASS. The UE 10 monitors the downlink signal in the On duration depending on the DRX cycle that is identified by the DRX_CYCLE_INDEX. Here, the eNB 110 may notify the DRX cycle or one that indicates the DRX cycle in addition to notifying the DRX_CYCLE_INDEX, or instead of notifying the DRX_CYCLE_INDEX.

For example, the UE_CATEGORY_CLASS indicates any one of (A) the type of the UE 10 (hereinafter, referred to as UE type), (B) a time zone in which the UE 10 operates (hereinafter, referred to as operation time zone), (C) a time in which the idle state of the UE 10 continues (hereinafter, referred to as continued time), (D) a power supply state of an apparatus with which the UE 10 is connected (hereinafter, referred to as power supply state), (E) the remaining amount of the battery supplying power to the UE 10 (hereinafter, referred to as battery remaining amount), (F) the moving speed of the UE 10 (hereinafter, referred to as moving speed), and (G) the type and the number of applications operating on the UE 10 or an apparatus with which the UE 10 is connected (hereinafter, referred to as application).

### (A) UE Type

The UE type is the type of a communication module or the like equipped in an apparatus such as a cell phone, a vehicle, or a household appliance, for example. An operation state of the UE 10 may differ depending on the type of the UE 10, for example, because the type of the communication module and the like of the UE 10 differs. The UE_CATEGORY_CLASS indicates the type category of the UE 10.

For example, the UE_CATEGORY_CLASS indicating the type of the certain UE 10 is associated with a DRX_CYCLE_INDEX corresponding to a longer DRX cycle or the DRX cycle compared to the UE_CATEGORY_CLASS indicating the type of another UE 10.

### (B) Operation Time Zone

An operation time zone is a time zone of nighttime and daytime, for example. The operation state of the UE 10 may differ depending on the time zone. The UE_CATEGORY_CLASS indicates the operation category of the UE 10.

For example, the UE_CATEGORY_CLASS indicating the time zone in which a communication frequency is low is associated with a DRX_CYCLE_INDEX corresponding to a longer DRX cycle or the DRX cycle compared to the UE_CATEGORY_CLASS indicating the time zone in which a communication frequency is high.

### (C) Continued Time

As described above, a continued time is a time in which the idle state of the UE 10 continues. For example, the continued time is a time in which the idle state continues from the timing when the UE 10 is transitioned to the idle state along with terminating the operation of the UE 10. Alternatively, when the UE 10 is a communication module equipped in an apparatus, the continued time is a time in which the idle state continues from the timing when the UE 10 is transitioned to the idle state along with termination of a communication request from the apparatus to the UE 10. The UE_CATEGORY_CLASS indicates the operation category of the UE 10.

For example, the UE_CATEGORY_CLASS indicating the longer continued time of the idle state is associated with a DRX_CYCLE_INDEX corresponding to a longer DRX cycle or the DRX cycle compared to the UE_CATEGORY_CLASS indicating shorter continued time of the idle state.

### (D) Power Supply State

As described above, the power supply state is the power supply state of the apparatus with which the UE 10 is connected. The operation state of the UE 10 may differ depending on the power supply state of the apparatus. The UE_CATEGORY_CLASS indicates the status category of the UE 10.

For example, when the UE 10 is a communication module equipped in a vehicle, the power supply state is a state of the vehicle engine (or the motor). Alternatively, when the UE 10 is a communication module equipped in a household appliance, the power supply state is a state of the power supply of the household appliance.

Here, the power supply state may indicate that a predetermined time elapsed from the timing when the power supply of the apparatus with which the UE 10 is connected is cut off. For example, the power supply state may also indicate that a predetermined time elapsed from the timing when a switch of the vehicle engine (or the motor) is turned off, or may also indicate that a predetermined time elapsed from the timing when the power supply of the household appliance is cut off.

For example, the UE_CATEGORY_CLASS indicating that the time elapsed after the power supply of the apparatus with which the UE 10 is connected is cut off is a longer time is associated with a DRX_CYCLE_INDEX corresponding to a longer DRX cycle or the DRX cycle compared to the UE_CATEGORY_CLASS indicating that the elapsed time after the power supply of the apparatus with which the UE 10 is connected is cut off is a shorter time.

### (E) Battery Remaining Amount

The battery remaining amount is the remaining amount of the battery supplying power to the UE 10. The operation state of the UE 10 (for example, an energy-saving mode) may change depending on the battery remaining amount. The UE_CATEGORY_CLASS indicates the status category of the UE 10.

For example, when the UE 10 is a cell phone, the battery remaining amount is the remaining amount of the battery provided in the cell phone. Alternatively, when the UE 10 is the communication module equipped in the apparatus, the battery remaining amount is the remaining amount of the battery provided in the apparatus. In such a case, the battery remaining amount may also be the battery remaining amount assigned to the UE 10 in the remaining amount of the battery provided in the apparatus.

For example, the UE_CATEGORY_CLASS indicating that the battery remaining amount of the UE 10 is less is associated with a DRX_CYCLE_INDEX corresponding to a longer DRX cycle or the DRX cycle compared to the UE_CATEGORY_CLASS indicating that the battery remaining amount of the UE 10 is more.

### (F) Moving Speed

As described above, the moving speed is the moving speed of the UE 10. The operation state (for example, a measurement cycle of the reception quality, or a reporting cycle of the measurement result of the reception quality of the downlink signal) of the UE 10 may change depending on the moving speed. The UE_CATEGORY_CLASS indicates the operation category of the UE 10.

For example, the UE_CATEGORY_CLASS indicating that the moving speed of the UE 10 is slower is associated with a DRX_CYCLE_INDEX corresponding to a longer DRX cycle or the DRX cycle compared to the UE_CATEGORY_CLASS indicating that the moving speed of the UE 10 is faster.

(G) Application

As described above, the application is the application executed on the UE 10 or on the apparatus with which the UE 10 is connected. The operation state of the UE 10 (for example, whether or not the certain application is being executed, whether or not the number of the applications being executed is more than the predetermined number) may change depending on the type and the number of the applications. The UE_CATEGORY_CLASS indicates the status category of the UE 10.

For example, the UE_CATEGORY_CLASS indicating the application of which communication frequency is lower is associated with a DRX_CYCLE_INDEX corresponding to a longer DRX cycle or the DRX cycle compared to the UE_CATEGORY_CLASS indicating the application of which communication frequency is higher.

### Radio Terminal

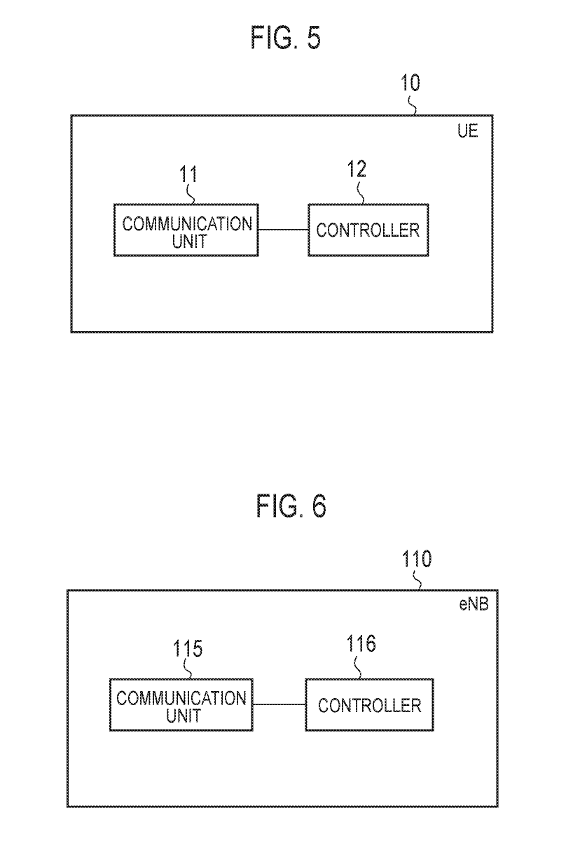

A radio terminal according to the first embodiment will be described, below. FIG. 5 is a block diagram illustrating the UE 10 according to the first embodiment. As illustrated in FIG. 5, the UE 10 includes a communication unit 11 and a controller 12.

The communication unit 11 receives a signal from the eNB 110 (or the radio base station 210). Alternatively, the communication unit 11 transmits a signal to the eNB 110 (or the radio base station 210). It is noted that the communication unit 11 includes, for example, an antenna (a plurality of antennas when MIMO is used), a demodulation unit, and a modulation unit.

In the first embodiment, the communication unit 11 notifies the eNB 110 (or the radio base station 210) of the UE_CATEGORY_CLASS indicating the category of the UE 10. Thereafter, the communication unit 11 receives, from the eNB 110 (or the radio base station 210), the DRX_CYCLE_INDEX for identifying the DRX cycle that is determined depending on the UE_CATEGORY_CLASS notified by the communication unit 11.

The controller 12 controls the UE 10. For example, when the discontinuous reception (DRX) is configured, the controller 12 controls on/off of the communication unit 11. That is, in the On duration in which a downlink signal is monitored, the controller 12 turns on the communication unit 11 and monitors the downlink signal (for example, the PDCCH) transmitted from the eNB 110. In the Off duration in which the downlink signal is not monitored, the controller 12 turns off the communication unit 11 and does not monitor the downlink signal (for example, the PDCCH) transmitted from the eNB 110.

In the first embodiment, the controller 12 instructs the communication unit 11 to notify the UE_CATEGORY_CLASS indicating the category of the UE 10 depending on the detection of a predetermined trigger.

When the UE_CATEGORY_CLASS indicates unchanged information (for example, the UE type), the predetermined trigger may be, for example, a location registration, or transition from the idle state to the connected state of the UE 10. In such a case, the UE_CATEGORY_CLASS may be included in a location registration message or an RRC connection message.

Alternatively, when the UE_CATEGORY_CLASS indicates variable information (for example, the operation time zone, the continued time, the power supply state, the battery remaining amount, or the communication speed), the predetermined trigger, for example, may be a timing when the operation state of the UE 10 changes.

Specifically, when the UE_CATEGORY_CLASS is the operation time zone, the predetermined trigger is that the time zone in which the UE 10 operates is switched. When the UE_CATEGORY_CLASS is the continued time, the predetermined trigger is that the time in which the idle state continues reaches the predetermined time. When the UE_CATEGORY_CLASS is the power supply state, the predetermined trigger is that the power supply of the apparatus is cut off or the predetermined time elapses from the timing when the power supply of the apparatus is cut off. When the UE_CATEGORY_CLASS is the battery remaining amount, the predetermined trigger is that the battery remaining amount falls below the predetermined threshold value or the battery remaining amount exceeds the predetermined threshold value. When the UE_CATEGORY_CLASS is the moving speed, the predetermined trigger is that the moving speed of the UE 10 falls below the predetermined threshold value or the moving speed of the UE 10 exceeds the predetermined threshold value.

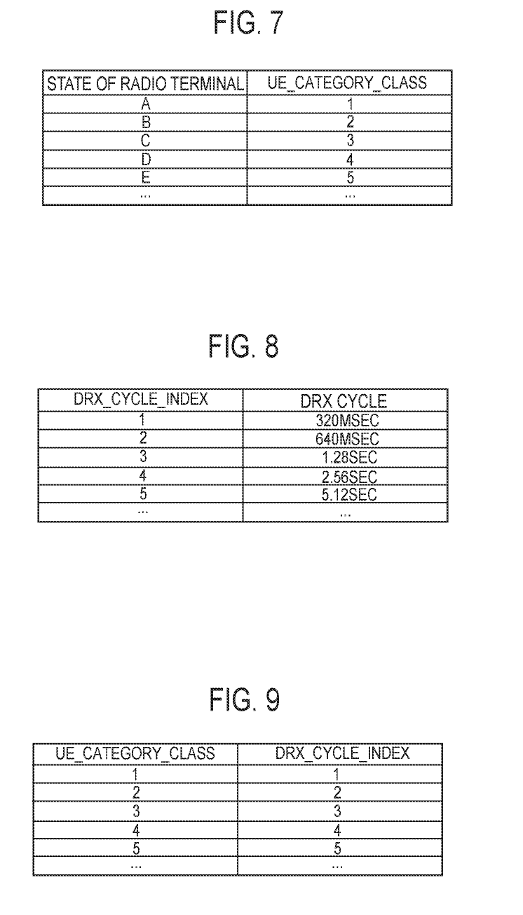

The controller 12 specifies the UE_CATEGORY_CLASS corresponding to the category of the UE 10 with reference to a table illustrated in FIG. 7, for example. In the table illustrated in FIG. 7, the category of the UE 10 is associated with the UE_CATEGORY_CLASS.

In the first embodiment, the controller 12 monitors the downlink signal in the On duration depending on the DRX cycle that is identified by the DRX_CYCLE_INDEX received from the eNB 110 (or, the radio base station 210). As described above, the DRX_CYCLE_INDEX is determined depending on the UE_CATEGORY_CLASS.

The controller 12 specifies the DRX cycle corresponding to the DRX_CYCLE_INDEX with reference to a table illustrated in FIG. 8, for example. In the table illustrated in FIG. 8, the DRX_CYCLE_INDEX is associated with the DRX cycle.

### Radio Base Station

The radio base station according to the first embodiment will be described, below. Here, the eNB 110 is exemplified as a radio base station, however, the embodiment is not limited thereto. The radio base station may be the radio base station 210. FIG. 6 is a block diagram illustrating the eNB 110 according to the first embodiment. As illustrated in FIG. 6, the eNB 110 includes a communication unit 115 and a controller 116.

The communication unit 115 receives a signal from the UE 10. Alternatively, the communication unit 115 transmits a signal to the UE 10. It is noted that, the communication unit 115 includes, for example, an antenna, a demodulation unit, and a modulation unit.

In the first embodiment, the communication unit 115 receives, from the UE 10, the UE_CATEGORY_CLASS indicating the category of the UE 10. The communication unit 115 notifies the UE 10 of the DRX_CYCLE_INDEX for identifying the DRX cycle that is determined depending on the UE_CATEGORY_CLASS.

The controller 116 controls the eNB 110. For example, the controller 116 assigns a resource for the UE 10 to transmit the uplink signal or a resource for the UE 10 to receive the uplink signal.

In the first embodiment, the controller 116 determines the DRX cycle depending on the UE_CATEGORY_CLASS received from the UE 10. The controller 116 instructs the communication unit 115 to notify the DRX_CYCLE_INDEX indicating the DRX cycle that is determined depending on the UE_CATEGORY_CLASS.

The controller 116 specifies the DRX_CYCLE_INDEX corresponding to the UE_CATEGORY_CLASS with reference to a table illustrated in FIG. 9, for example. In the table illustrated in FIG. 9, the UE_CATEGORY_CLASS is associated with the DRX_CYCLE_INDEX. The specification of the

DRX_CYCLE_INDEX is synonymous with the determination of the DRX cycle because the DRX_CYCLE_INDEX is associated with the DRX cycle one to one.

### Mobile Communication Method

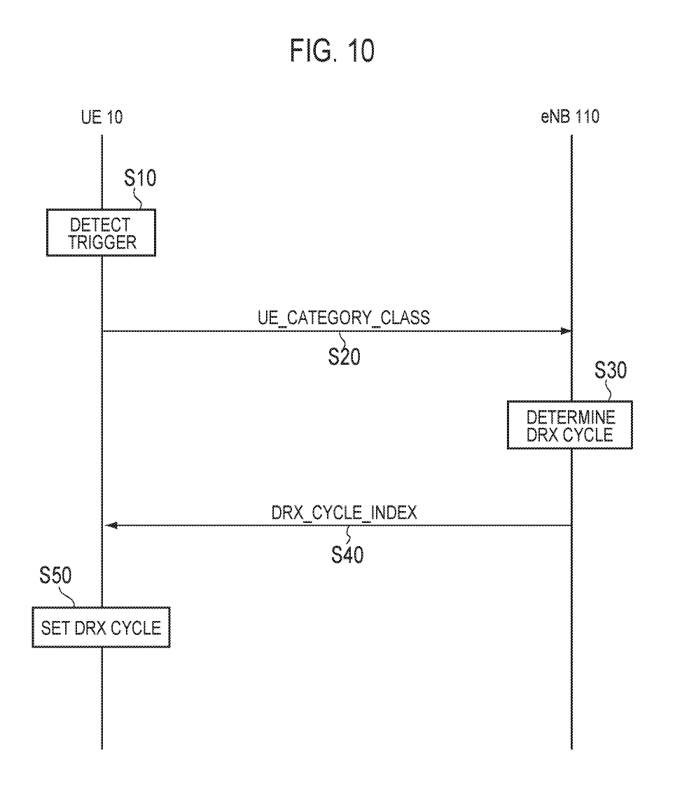

A mobile communication method according to the first embodiment will be described, below. FIG. 10 is a sequence diagram illustrating the mobile communication method according to the first embodiment. Here, the eNB 110 is exemplified as a radio base station, however, the embodiment is not limited thereto. The radio base station may be the radio base station 210.

As illustrated in FIG. 10, in step S10, the UE 10 detects a predetermined trigger. It should be noted that the predetermined trigger differs depending on the category of the UE 10 as described above.

In step S20, the UE 10 notifies the eNB 110 of the category class indicating the category of the UE 10 (UE_CATEGORY_CLASS).

In step S30, the eNB 110 determines the DRX cycle depending on the UE_CATEGORY_CLASS. As described above, the eNB 110 may specify the DRX_CYCLE_INDEX corresponding to the UE_CATEGORY_CLASS with reference to the table illustrated in FIG. 9.

In step S40, the eNB 110 notifies the UE 10 of DRX identification information (DRX_CYCLE_INDEX) for identifying the DRX cycle that is determined depending on the UE_CATEGORY_CLASS.

In step S50, the UE 10 monitors the downlink signal in the On duration depending on the DRX cycle that is identified by the DRX_CYCLE_INDEX.

### Operation and Effect

In the first embodiment, it is possible to set the appropriate DRX cycle because the DRX cycle is determined depending on the category of the UE 10 by notifying the eNB 110, from the UE 10, of the category of the UE 10 that is allowed to be recognized only in the UE 10.

That is, in the conventional mobile communication method, the same DRX cycle is fixedly prescribed in a cell. However, in the first embodiment, it is possible to flexibly set the DRX cycle.

It should be noted that the DRX cycle determined depending on the category of the UE 10 differs from the conventional DRX cycle (for example, the short DRX cycle or the long DRX cycle) in that the DRX cycle is determined by regarding a signal notified to the eNB 110 from the UE 10 as a trigger.

### Other Embodiments

The present invention is described through the above-described embodiments, but it should not be understood that this invention is limited by the statements and the drawings constituting a part of this disclosure. From this disclosure, various alternative embodiments, examples, and operational technologies will become apparent to those skilled in the art.

Although not particularly mentioned in the embodiment, the table in which the UE_CATEGORY_CLASS is associated with the DRX_CYCLE_INDEX (see FIG. 9) may differ depending on an installation place of the radio base station (a busy street, a countryside, etc.).

When the UE_CATEGORY_CLASS is notified to the eNB 110 from the UE 10 in the idle state, it is preferable that the UE 10 notifies the UE_CATEGORY_CLASS after the transition from the idle state to the connected state, and then the UE 10 is transitioned from the connected state to the idle state. Alternatively, a message to notify the UE_CATEGORY_CLASS may also be various uplink messages transmitted from the UE, and may be transmitted via the uplink control channel (PUCCH) or the uplink shared channel (PUSCH).

It is noted that the entire content of Japanese Patent Application No. 2013-170239 (filed on Aug. 20, 2013) is incorporated in the present description by reference.

### INDUSTRIAL APPLICABILITY

According to the present invention, it is possible to provide a mobile communication system and a radio terminal with which it is possible to set an appropriate DRX cycle.

1. A mobile communication method, comprising:
notifying a radio base station, from a radio terminal, of a category class indicating a category of the radio terminal,
notifying the radio terminal, from the radio base station, of DRX identification information for identifying a DRX cycle that is determined depending on the category class, wherein the DRX cycle including an On duration in which the downlink signal is monitored and an Off duration in which the downlink signal is not monitored, and
monitoring a downlink signal in the On duration in the radio terminal depending on the DRX cycle that is identified by the DRX identification information.

2. The mobile communication method according to claim 1, wherein
the category of the radio terminal is a category indicating at least any one of an operation, a type, or a status of the radio terminal.

3. The mobile communication method according to claim 1, wherein
the radio terminal transmits the category class to the radio base station depending on a change in an operation state of the radio terminal.

4. The mobile communication method according to claim 1, wherein
the category class indicates any one of a type of the radio terminal, a time zone in which the radio terminal operates, a time in which an idle state of the radio terminal continues, a power supply state of an apparatus with which the radio terminal is connected, a remaining amount of a battery supplying power to the radio terminal, a moving speed of the radio terminal, and an application that is executed by the radio terminal or by an apparatus with which the radio terminal is connected.

5. A radio terminal, comprising:
at least one processor configured to performing processes of
notifying a radio base station of a category class indicating a category of the radio terminal,
monitoring a downlink signal in a On duration depending on a DRX cycle that is determined by the radio base station depending on the category class of the radio terminal, and wherein
the DRX cycle including an On duration in which the downlink signal is monitored and an Off duration in which the downlink signal is not monitored.

6. A radio base station, comprising:
at least one processor configured to performing processes of
receiving a category class indicating a category of a radio terminal from the radio terminal,
notifying the radio terminal of DRX identification information for identifying a DRX cycle that is determined depending on the category class of the radio terminal, and wherein
the DRX cycle including an On duration in which a downlink signal is monitored and an Off duration in which the downlink signal is not monitored.

7-9. (canceled)
